(19) United States
(12) Patent Application Publication
(10) Pub. No.: US 2018/0170737 A1
(43) Pub. Date: Jun. 21, 2018

(54) SWIVEL ARRANGEMENT FOR A CAROUSEL FILLER

(71) Applicant: Tetra Laval Holdings & Finance S.A., Pully (CH)

(72) Inventor: Lasse Andersen, Hörby (SE)

(21) Appl. No.: 15/739,643

(22) PCT Filed: Jun. 23, 2016
(86) PCT No.: PCT/EP2016/064519

§ 371 Date: Dec. 22, 2017

(30) Foreign Application Priority Data
Jul. 1, 2015 (SE) 15509326

(51) Int. Cl. B67C 3/22; B65B 3/00

(52) U.S. Cl. CPC B67C 3/22; F16L 27/0804; B67C 2003/228; B65B 3/00

(57) ABSTRACT

The invention relates to a swivel arrangement for a carousel filler having a rotating tank (2) and a product pipe (4) for transporting product into the rotating tank, is provided. The swivel arrangement comprises a tank connecting part (6) arranged to rotate with the rotating tank, a product pipe connecting part (5) arranged to at least partly surround the tank connecting part and an intermediate part (7) arranged between the tank connecting part and the product pipe connecting part, the intermediate part being arranged to rotate with a rotational speed different from a rotational speed of the tank connecting part. The invention also relates to a carousel filler comprising such a swivel arrangement.

### TECHNICAL FIELD

The present invention relates to a swivel arrangement for a carousel filler, further the present invention relates to a carousel filler having such a swivel arrangement.

### BACKGROUND ART

In food processing industry, carousel fillers are used to fill packages with different types of beverages. In order to ensure that certain types of beverages, e.g. beverages containing particles or media which may sediment, are evenly distributed or that the quality is uniform the carousel filler may have a rotating tank. The rotating tank is refilled by a product pipe extending from above the tank, into the tank through a swivel arrangement. In order to keep the environment in the tank sterile, the swivel arrangement may be subjected to, or contain channels for hot steam and/or channels for sterile air. Hence, there are many features included and consideration made while designing the swivel arrangement due to the requirements on the sterile environment for the tank or product which inherently consume much energy such as heated steam or make the swivel arrangement complex and thus expensive to manufacture. Further, due to the above consideration for keeping a sterile environment, the rotational speed of the rotating tank and thus carousel filler is limited, as components such as bearings and bushings taking up large amount of the load would otherwise fail with an unacceptable frequency. Furthermore, there is desire to reduce the amount of regular maintenance of the swivel arrangement and components therein.

Hence, there is a generally desire to provide reduced costs and improved performance. One desired effect may be a reduced cost or complexity of the swivel arrangement to provide a sterile environment sterilization and/or improved sterilization. Another desired effect may be a swivel arrangement which allows an increased rotational speed. The increased rotational speed would be advantageous in terms of the filling speed for each package and thus cost. Another desired effect may be a reduced cost for maintenance. There is thus a need for improving the state of the art to provide for swivel arrangement for a carousel filler which at least partly solves these problems or provides the desired effect.

### SUMMARY OF THE INVENTION

It is an object of the present invention to improve the current state of the art, to solve at least some of the above problems, and to provide an improved swivel arrangement and thus carousel filler. These and other objects are achieved by a swivel arrangement for a carousel filler, and carousel filler comprising a swivel arrangement.

According to a first aspect of the present invention, a swivel arrangement for a carousel filler having a rotating tank and a product pipe for transporting product into the rotating tank, is provided. The swivel arrangement comprises a tank connecting part arranged to rotate with the rotating tank, a product pipe connecting part arranged to at least partly surround the tank connecting part and an intermediate part arranged between the tank connecting part and the product pipe connecting part, the intermediate part being arranged to rotate with a rotational speed different from a rotational speed of the tank connecting part.

The present invention is based on the realization that an intermediate part arranged between a tank connecting part and a pipe connecting part for a carousel filler having a rotating tank and an product pipe for transporting product into the tank allows the relative speed between the tank connecting part and the pipe connecting part to be reduced as the intermediate part is arranged to rotate with a rotational speed different from a rotational speed of the tank connecting part. Hence, components comprised in the swivel arrangement will experience less wear and tear. Thus, the swivel arrangement according to the present invention has an increased lifetime and may increase the lifetime of component within the swivel arrangement. Another advantage is that since the intermediate part reduces the relative speed, the tank connecting part, and hence the rotating tank may be allowed an increased rotational speed. Hence, the present invention may also be used to provide a carousel filler with a higher rotational speed which may be used to fill more packages per hour.

A product pipe of a carousel filler extends into the tank in order to transport, i.e. refill or fill, product into the tank. As the product pipe is further connected to other parts such as pumps, filter and processing equipment before the product reaches the carousel filler the product pipe is stationary and non-rotating.

The swivel arrangement may also be known as a manifold assembly, as the purpose of the swivel arrangement is to connect the rotating tank to the product pipe and possibly to other connections while allowing the rotating tank to, in use, rotate.

The swivel arrangement may comprise at least a first bushing arranged between the tank connecting part and the intermediate part, and at least a second bushing arranged between the pipe connecting part and the intermediate part. The first bushing is arranged between the surfaces of the tank connecting part and the intermediate part in order to provide a bearing surface between the tank connecting part and the intermediate part. The second bushing is arranged between the surfaces of the pipe connecting part and the intermediate part in order to provide a bearing surface between the pipe connecting part and the intermediate part. The intermediate part, in use, rotates with a rotational speed different, e.g. lower, than the tank connecting part the first and second bushings experiences less wear and tear and thus lasts longer before requiring maintenance or replacement.

The swivel arrangement may comprise a first set of seals arranged between the tank connecting part and the intermediate connecting part, and a second set of seals arranged between the pipe connecting part and the intermediate connecting part. The first and second set of seal are arranged to prevent contaminations from entering the tank, and as the intermediate part, in use, rotates with a rotational speed different, e.g. lower, than the tank connecting part the first and second set of seals experiences less wear and tear and thus lasts longer before requiring maintenance or replacement.

In some embodiments of the invention, the intermediate part may be arranged to rotate at a rotational speed of half the rotational speed of the tank connecting part. By arranging the intermediate part to rotate at half the rotational speed of the tank connecting part less wear and tear is inflicted on the component of the swivel arrangement.

In various embodiments of the invention, the pipe connecting part may be stationary and non-rotating. Hence, the pipe connecting part may be attached to the product pipe of a carousel filler which is typically stationary.

In some embodiments of the invention, the intermediate part may comprise a radial portion extending in a radial direction as seen from an axis of rotation. The radial portion may be connectable to external means for driving the intermediate part. An axis of rotation refers to the common axis of rotation of the swivel arrangement. The common axis of rotation is the same or substantially similar axis of rotation as the axis of rotation for the tank connecting part.

In at least one exemplary embodiment of the invention, the intermediate part may be arranged to be driven by internal means for driving the intermediate part. Thereby, no additional component and thus costs may be required to provide the intermediate part with a rotational speed different from the tank connecting part. The internal means for driving the intermediate part may be at least one of: a gear connected to the tank connecting part, a bushing, a rolling bearing, a friction surface. The intermediate part should thus be interpreted to be mechanically connected to the tank connecting part which rotates, and provides the torque required to rotate the intermediate part. The gear may be arranged between the tank connect part and the intermediate part and provide a gear ratio such that the intermediate part rotates with a rotational speed which is less than the rotational speed of the tank connecting part.

In various embodiments of the invention, the tank connecting part may be arranged to rotate at at least 12 RPM, and preferable at at least 20 RPM, and more preferably at at least 24 RPM.

In various embodiments of the invention, the intermediate part may be arranged to rotate at at least 6 RPM, and preferable at at least 10 RPM, and more preferably at at least 12 RPM.

According to various embodiment of the present invention, the swivel arrangement may further comprise a first opening at least for receiving a gaseous media, a second opening at least for ejecting the gaseous media, a first channel being in fluid communication with the first opening, the first channel being at least partly defined by a protruding portion of the pipe connecting part and an outer wall of the product pipe, a second channel being in fluid communication with the first channel, the second channel being at least partly defined by the protruding portion and a protruding portion of the tank connecting part. A gap is formed between the pipe connecting part and the protruding portion of the tank connecting part, the gap being located between the second channel and the second opening thereby forming a particle barrier whereby, in use, particles are hindered from entering the second channel by a flow of gaseous media from the first opening to the second opening via first and second channels.

According to one exemplary embodiment of the present invention, the swivel arrangement may further comprise a steam inlet, a steam outlet, and a steam channel defined between the steam inlet and the steam outlet, the channel at least partly being defined between the intermediate part and the flow of gaseous media in order to steam sterilize particles between the steam channel and the gap.

According to at least a second aspect of the present invention, a carousel filler is provided. The carousel filler comprises a rotating tank, a product pipe for transporting product into the rotating tank and a swivel arrangement. The swivel arrangement comprises a tank connecting part arranged to rotate with the rotating tank, a pipe connecting part arranged to at least partly surround the tank connecting part, and an intermediate part arranged between the tank connecting part and the pipe connecting part, the intermediate part being arranged to rotate with a rotational speed different from a rotational speed of the tank connecting part.

Effects and features of this second aspect of the present invention are largely analogous to those described above in connection with the first aspect of the inventive concept. Embodiments mentioned in relation to the first aspect of the present invention are largely compatible with the second aspect of the invention.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements, wherein:

FIG. 1 is a cross-sectional schematic view of portions of a carousel filler in accordance with at least one embodiment of the invention;

FIG. 2 is a cross-sectional schematic view of a swivel arrangement for a carousel filler in accordance with at least one embodiment of the invention;

FIG. 3 is a cross-sectional schematic view of a swivel arrangement for a carousel filler in accordance with at least one embodiment of the invention; and

FIG. 4 is a cross-sectional schematic view of a swivel arrangement for a carousel filler in accordance with at least one embodiment of the invention.

### DETAILED DESCRIPTION OF PREFERRED EMBODIMENTS OF THE INVENTION

In the present detailed description, embodiments of a carousel filler and swivel arrangement according to the present invention are mainly discussed with reference to cross sectional schematic views showing a swivel arrangement according to various embodiments of the invention. It should be noted that this by no means limits the scope of the invention, which is also applicable in other circumstances for instance with other types or variants of carousel fillers or devices than the embodiments shown in the appended drawings. Further, that specific components are mentioned in connection to an embodiment of the invention does not mean that those components cannot be used to an advantage together with other embodiments of the invention. The invention will now be described with reference to the enclosed drawings where first attention will be drawn to the structure, and secondly to the function.

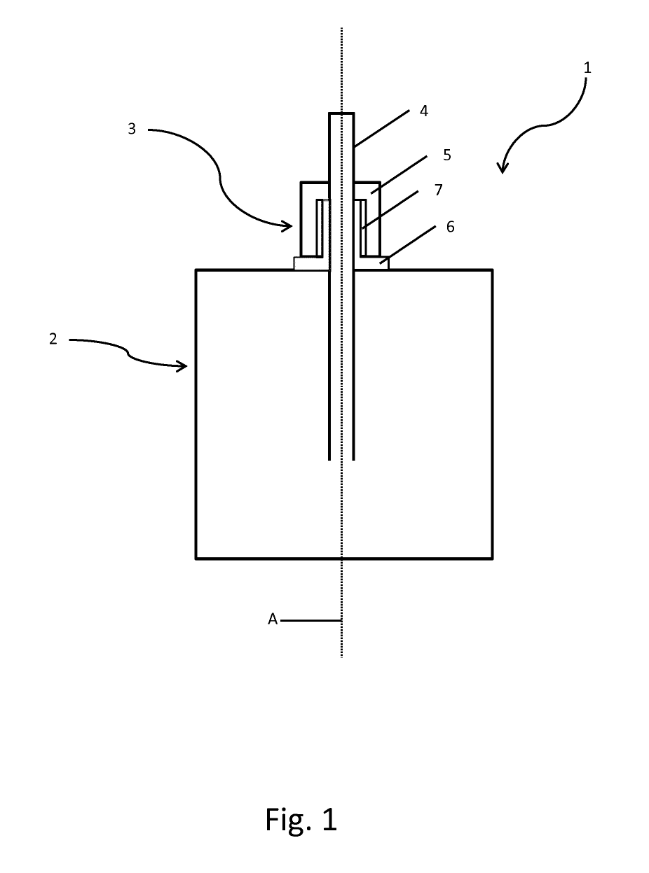

FIG. 1 shows a cross-sectional schematic view of a carousel filler 1 in accordance with one embodiment of the present invention. The carousel 1 filler comprises a rotating tank 2, a swivel arrangement 3 and a product pipe 4. It should of course be noted that a complete carousel filler comprises more components than the ones shown herein in order to properly function such as pipe and valves leading to packages to be filled by the liquid product in the rotating tank 2. However, such components are left out as many alternatives are known in the art and the focus of the present invention is the swivel arrangement 2. Further, it is understood that the carousel filler 1, the rotating tank 2, the swivel arrangement 3 and the product pipe 4 are substantially rotationally symmetric around a common axis A which is also the axis of rotation for the rotating tank 2 and the swivel arrangement 3.

The swivel arrangement 3 comprises a tank connecting part 6, a pipe connecting part 5 and an intermediate part 7. The intermediate part 7 is arranged between the tank connecting part 6 and the pipe connecting part 5. The pipe connecting part 5 at least partly surrounds the tank connecting part 6 in a radial direction as seen from the rotational axis A. The tank connecting part 6 is mounted on and attached to the rotating tank 2, such that the tank connecting part 6, in use, rotates with the rotating tank 2. The product pipe 4 is arranged to transport a product in liquid form into the tank 2. The product pipe 4 therefore extends into the rotating tank 2, from above the rotating tank 2 as shown in FIG. 1. Hence, the swivel arrangement 3 is understood to be mounted on top of the rotating tank 2. The product pipe 4 is stationary and non-rotating as valves and other connection which feed the product from other parts of the production into the product pipe 4 limits the movement of the product pipe 4. The product pipe 4 is connected to the pipe connecting part 5 of the swivel arrangement 3. The intermediate part 7 is arranged between the tank connecting part 6 and the pipe connecting part 5.

In use, the rotating tank 2 rotates around the axis of rotation A. The axis of rotation A may be the common axis of rotation, e.g. substantially the same axis of rotation as the axis of rotation for the tank connecting part 6 and the intermediate part 7. The rotating tank 2 and thus the tank connecting part 6 is arranged to rotate at at least 12 RPM, and preferable at at least 20 RPM, and more preferably at at least 24 RPM. The intermediate part 7 is arranged to to rotate with a rotational speed different from a rotational speed of said tank connecting part 6. Typically the intermediate part 7 is arranged to rotate with a rotational speed which is half of the rotational speed of the tank connecting part 6 such that the intermediate part 7 is arranged to rotate at at least 6 RPM, and preferable at at least 10 RPM, and more preferably at at least 12 RPM with reference to the above given rotational speeds of the tank connecting part 6. While the rotating tank 2 rotates, pipe and valves (not shown) fill packages (not shown) in the vicinity of the carousel filler 1 with the liquid product kept in the rotating tank 2. The amount of liquid product in the rotating tank 2 may be kept substantially constant by being continuously refilled through the product pipe 4.

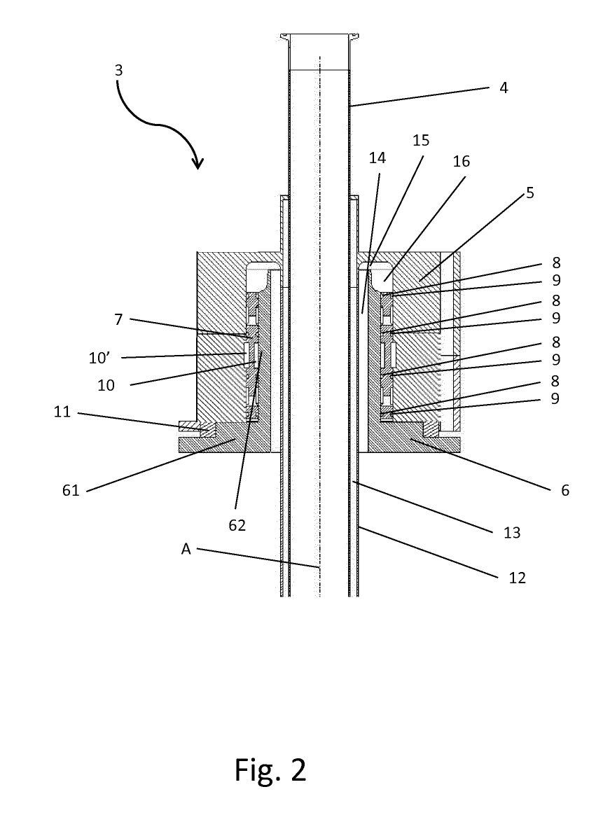

FIG. 2 shows a more detailed cross sectional view of the swivel arrangement 3 in accordance with at least one embodiment of the invention. Note that the tank connecting part 6 comprises a base plate 61 and a protruding portion 62 which extends from the base plate 61. The base plate 61 has a radial extension from the axis of rotation A and the protruding portion 62 extends in parallel with the axis of rotation A. The intermediate part 7 is elongated and arranged with its longitudinal axis in parallel with the axis of rotation A. The intermediate part 7 is arranged in a radial direction from the protruding portion 62 between the protruding portion 62 and the pipe connecting part 5. Hereby, it is understood that protruding portion 62 of the tank connecting part is shaped in the form of a cylinder, and that the intermediate part 7 is formed as a cylinder which at least partly surrounds the protruding portion 62 of the tank connecting part. The pipe connecting part 5 thus surrounds the intermediate part 7 and the protruding portion 62 of the tank connection part in radial direction from the axis of rotation A.

The swivel arrangement further comprises a rolling bearing 11 arranged between the base plate 61 of the tank connecting part 6 and the pipe connecting part 5 in order to allow them to freely rotate with respect to each other.

The swivel arrangement 3 comprises a first set of seals 8 arranged between the tank connecting part 6 and the intermediate part 7, and a second set of seals 9 arranged between the pipe connecting part 5 and the intermediate part 7. The first and second set of seal 8, 9 prevents contaminations from entering the tank through a path between the tank connecting part 6 and the intermediate part 7 and a path between the pipe connecting part 5 and the intermediate part 7. The seals 8, 9 may be made of any suitable material such as rubber, synthetic rubber, a plastic, a ceramic or the like.

The swivel arrangement 3 comprises a first bushing 10 arranged between the tank connecting part 6 and the intermediate part 7, and a second bushing 10′ arranged between the pipe connecting part 5 and the intermediate part 7.

The intermediate part 7 shown in FIG. 1 may be driven by internal means for driving the intermediate part 7. The internal means for driving the intermediate part may be at least one of: a gear (not shown) connected to the tank connecting part, a bushing, a rolling bearing. Hence, as is shown in FIG. 1 the intermediate 7 part is mechanically connected to the tank connecting part 6 through e.g. the first and second bushing 10, 10′ which are configured to provide the torque required to rotate the intermediate part 7. A gear (not shown) may be arranged between the tank connecting part 6 and the intermediate part 7 and provide a gear ratio such that the intermediate part rotates with a rotational speed which is less than the rotational speed of the tank connecting part. Hence, it should be understood that the internal means for driving the intermediate part drives the intermediate part 7 in the same rotational directions as the tank connecting part 6.

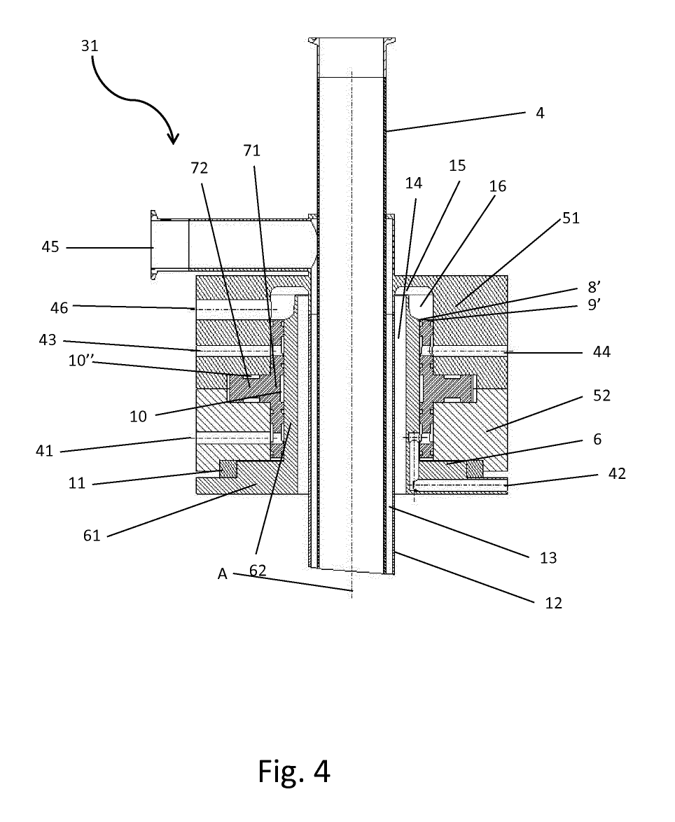

The pipe connecting part 5 comprises a protruding portion 12 extending in parallel with the product pipe 4. The protruding portion 12 together with the outer wall of the product pipe 4 defines a first channel 13. The protruding portion 12 also defines a second channel 14 together with protruding portion 62 the tank connecting part 14. The second channel 14 is in fluid communication with a gap 15 defined between the protruding portion 62 of the tank connecting part 6 and the pipe connection part 5. The gap 15 is in fluid communication with a chamber 16, and the further working of the first channel 13, second channel 14, gap 15 and chamber 16 are further explained below in connection to FIG. 4.

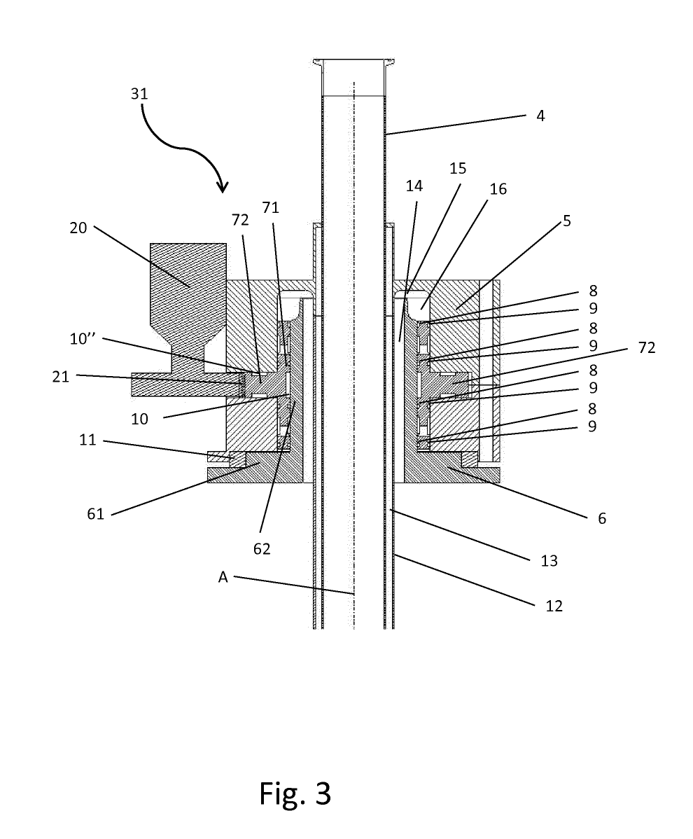

FIG. 3 shows a cross-sectional schematic view of a swivel arrangement 31 in accordance with at least one embodiment of the invention. The same reference number refers to the same element as in FIG. 2, and those features and components are appreciated to be essentially similar. A difference between the embodiment shown in FIG. 3 and the embodiment shown in FIG. 2 is that the intermediate part comprises an axial portion 71 and a radial portion 72. The axial portion 71 extends substantially parallel to the axis of rotation A.

The radial portion 72 extends outwards in a radial direction from the axis of rotation A. The radial portion 72 comprises a gear 21 at the outer end in order to mesh and engage with external means 20 for driving the intermediate part. The external means 20 may be any suitable component or components providing the possibility to drive the intermediate part such as an electrical motor, a hydraulic motor, or connections to further means for driving the rotation of the intermediate part . Further means for driving the rotation of the intermediate part may be a chain, an additional gear, or a drive shaft.

Note that at second bushing 10″ in the embodiment shown in FIG. 3 is arranged at the radial portion 72 of the intermediate part in order to provide a bearing surface between the radial portion 72 of the intermediate part and the pipe connecting part 5.

FIG. 4 is a cross-sectional schematic view of the swivel arrangement 31 shown in FIG. 3 seen from another angle. In FIG. 4 channels for steam and sterile air flow is also shown. Further, the pipe connecting part comprises an upper portion 51 and a lower portion 52.

An air inlet 41 is provided in the lower portion 52 of the pipe connecting part. The air inlet 41 is in fluid communication with an air outlet 42 in the base plate 61 of the tank connecting part. During use, a flow of e.g. sterile air or the like may be led through the channel formed between the air inlet 41 and the air outlet 42 in order to prevent contaminants from entering or penetrating through the path between the lower portion 52 of the pipe connecting part and the intermediate part 71, 72, and between the lower portion 52 of the pipe connecting part and the protruding portion 62 of the tank connecting part.

The swivel arrangement 31 comprises a first opening 45 at least for receiving a gaseous media. The first opening 45 may be arranged outside the upper portion 51 of the pipe connecting portion as shown in FIG. 4. The swivel arrangement 31 comprises a second opening 46 at least for ejecting the gaseous media. As mentioned above in connection with FIG. 2 the first channel 13 at least partly defined by the protruding portion 12 of the pipe connecting part and an outer wall of the product pipe 4. The first channel 13 terminates in the tank at a tank opening (not shown) such that a flow of gaseous media which enters the first opening 45 is led through the first channel 13 to the tank opening (not shown), and may then enter the second channel 14, which is thereby in fluid communication with the first channel 14 via the rotating tank 2. The second channel 14 is at least partly defined by the protruding portion 12 of the pipe connecting part and the protruding portion of the tank connecting part 62. The gap is formed between the interior of the upper portion 51 of the pipe connecting part and an upper end of the protruding portion 62 of the tank connecting part. The gap is located between the second channel 14 and the second opening 46. During use, a continuous flow of gaseous media is directed from the first opening 45 to the second opening 46 via the first and second channels 12, 13. Thereby, a particle barrier is formed such that particles are hindered from entering the second channel 14 and falling into the tank where they may contaminate the product. The particle barrier is thus provided at least partly by the positive flow of a gaseous media through the second channel 14, and the gap 15, and partly by the protruding portion 62 of the tank connecting part which extends further than the chamber 16 such that the force of gravity pulls particles which have entered the chamber 16 away from the gap 15 as shown in FIG. 4.

The swivel arrangement 31 further comprises a steam inlet 43 and a steam outlet 44 formed in the upper portion 51 of the pipe connecting part. The steam inlet 43 is in in fluid communication with the steam outlet 44 via a steam channel defined between the steam inlet 43 and the steam outlet 44. During use, a flow of steam may be led between the first and second steam openings 43, 44. The flow of steam comprises steam at a temperature in the range of 90-200° C., preferably about 120° C. The flow of steam creates a steam barrier which sterilizes any contaminants which may have reached that position within the swivel arrangement 31. Note that the upper pair of seals 8′ and 9′ are arranged between the flow of steam and the chamber 16 and prevent the flow of steam from entering the chamber 16.

The terms ‘inlet’ and ‘outlet’ should in the above not be construed as limiting, it is of course possible that an inlet or an outlet be used the other way around, e.g. that the inlet functions as an outlet and vice versa where the flow through the inlet our outlet would provide the same function.

The skilled person realizes that a number of modifications of the embodiments described herein are possible without departing from the scope of the invention, which is defined in the appended claims.

25

1. A swivel arrangement for a carousel filler having a rotating tank and a product pipe for transporting a product into the rotating tank, the swivel arrangement comprising:
a tank connecting part arranged to rotate with the rotating tank;
a pipe connecting part arranged to at least partly surround the tank connecting part; and
an intermediate part arranged between the tank connecting part and the pipe connecting part, said intermediate part being arranged to rotate at a rotational speed different from a rotational speed of the tank connecting part.

2. The swivel arrangement according to claim 1, wherein the swivel arrangement comprises at least a first bushing arranged between the tank connecting part and the intermediate part, and at least a second bushing arranged between the pipe connecting part and the intermediate part.

3. The swivel arrangement according to claim 1, wherein the swivel arrangement comprises a first set of seals arranged between the tank connecting part and the intermediate part, and a second set of seals arranged between the pipe connecting part and the intermediate part.

4. The swivel arrangement according to claim 1, wherein the intermediate part is arranged to rotate at a rotational speed of half the rotational speed of the tank connecting part.

5. The swivel arrangement according claim 1, wherein the pipe connecting part is stationary and non-rotating.

6. The swivel arrangement according to claim 1, wherein the intermediate part comprises a radial portion extending in a radial direction as seen from an axis of rotation, and wherein the radial portion is connectable to an external intermediate part driver.

7. The swivel arrangement according to claim 1, wherein the intermediate part is arranged to be driven by an internal intermediate part driver.

8. The swivel arrangement according to claim 7, wherein the internal intermediate part driver is at least one of: a gear connected to the tank connecting part, a bushing, a rolling bearing, and a friction surface.

9. The swivel arrangement according to claim 1, wherein the tank connecting part is arranged to rotate at least at 12 RPM.

10. The swivel arrangement according to any claim 1, wherein intermediate part is arranged to rotate at least at 6 RPM.

11. The swivel arrangement according to claim 1, having a channel formed between the pipe connecting part and the intermediate part.

12. A swivel arrangement according to claim 1, further comprising:
a first opening at least for receiving a gaseous media;
a second opening at least for ejecting the gaseous media;
a first channel in fluid communication with the first opening, the first channel at least partly defined by a protruding portion of the pipe connecting part and an outer wall of the product pipe;
a second channel in fluid communication with the first channel, the second channel at least partly defined by the protruding portion of the pipe connecting part and a protruding portion of the tank connecting part;
wherein a gap is formed between an interior of the pipe connecting part and the protruding portion of the tank connecting part, the gap being located between the second channel and the second opening thereby forming a particle barrier whereby, when the swivel arrangement is in use, particles are hindered from entering the second channel by a flow of gaseous media from the first opening to the second opening via first and second channels.

13. The swivel arrangement according to claim 12, further comprising:
a steam inlet,
a steam outlet,
a steam channel defined between the steam inlet and the steam outlet, said channel at least partly being defined between the intermediate part and the flow of gaseous media in order to steam sterilize particles incident upon a seal arranged between the steam channel and the gap.

14. A carousel filler comprising:
a rotating tank;
a product pipe for transporting product into the rotating tank; and
a swivel arrangement comprising:
a tank connecting part arranged to rotate with the rotating tank;
a pipe connecting part arranged to at least partly surround the tank connecting part; and
an intermediate part arranged between the tank connecting part and the pipe connecting part, the intermediate part being arranged to rotate with a rotational speed different from a rotational speed of the tank connecting part.

15. The swivel arrangement according to claim 1, wherein the tank connecting part is arranged to rotate at least at 20 RPM.

16. The swivel arrangement according to any claim 1, wherein the intermediate part is arranged to rotate at least at 10 RPM.

17. The swivel arrangement according to claim 1, wherein the tank connecting part is arranged to rotate at least at 24 RPM.

18. The swivel arrangement according to any claim 1, wherein the intermediate part is arranged to rotate at least at 12 RPM.
